(19) United States
(12) Patent Application Publication
(10) Pub. No.: US 2021/0342658 A1
(43) Pub. Date: Nov. 4, 2021

(54) POLYSEMANT MEANING LEARNING AND SEARCH RESULT DISPLAY

(71) Applicant: BEIJING SANKUAI ONLINE TECHNOLOGY CO., LTD, Beijing (CN)

(72) Inventor: Hongsheng CHEN, Beijing (CN)

(21) Appl. No.: 17/265,151

(22) PCT Filed: Jul. 30, 2019
(86) PCT No.: PCT/CN2019/098463

§ 371 Date: Apr. 6, 2021

(30) Foreign Application Priority Data
Aug. 1, 2018 (CN) 201810864072.9

(51) Int. Cl. G06K 9/72; G06K 9/62; G06N 20/00

(52) U.S. Cl. CPC G06K 9/72; G06K 9/6215; G06K 9/6218; G06N 20/00; G06K 9/6232; G06K 9/6261; G06K 9/623

(57) ABSTRACT

A polysemant meaning learning method is provided. The method includes extracting a plurality of first target terms and at least one adjacent term combinations of each first target term; obtaining a capsule network model by training by taking the encoding of each first target term as an input vector and the encoding of each adjacent term combination corresponding to each first target term as an output vector; when a to-be-recognized second target term is recognized, inputting the second target term into the capsule network model, and determining a plurality of obtained intermediate vectors as feature vectors of the second target term; and clustering the feature vectors with a cosine similarity greater than a similarity threshold to generate representative terms of one or more categories and determining one or more meanings of the one or more categories.

This application is a US national stage of international application No. PCT/CN2019/098463, filed on Jul. 30, 2019, which claims priority to Chinese Patent Application No. 201810864072.9, filed on Aug. 1, 2018 and entitled “POLYSEMANT MEANING LEARNING METHOD AND APPARATUS, AND SEARCH RESULT DISPLAY METHOD.” Both applications are herein incorporated by reference in their entireties.

### TECHNICAL FIELD

The present disclosure relates to the field of computer technologies, and in particular, to polysemant meaning learning and search result display.

### BACKGROUND

With the development of the computer technologies, increasingly more attention is paid to artificial intelligence. As an important branch of artificial intelligence, natural language processing has been widely used in aspects such as search, intelligent customer service, machine translation, text proofreading, and autoabstract.

Polysemant meanings generally need to be recognized in natural language processing.

### SUMMARY

The present disclosure provides polysemant meaning learning and search result display.

According to one aspect of the present disclosure, a polysemant meaning learning method is provided, including: extracting a plurality of first target terms and at least one adjacent term combinations of each first target term from a to-be-learned text set; respectively encoding each first target term and each adjacent term combination according to a word bank of the to-be-learned text set; obtaining a capsule network model by training by taking the encoding of each first target term as an input vector and the encoding of each adjacent term combination corresponding to each first target term as an output vector; when a to-be-recognized second target term is recognized, inputting the second target term into the capsule network model, and determining a plurality of obtained intermediate vectors as feature vectors of the second target term; and clustering the feature vectors with a cosine similarity greater than a similarity threshold to generate representative terms of one or more categories to which the feature vectors of the second target term belong, and determining one or more meanings of the second target term according to the representative terms of one or more categories to which the feature vectors of the second target term belong.

According to one aspect of the present disclosure, an electronic device is provided, including: a processor; and a memory, configured to store executable instructions of the processor; the processor being configured to execute the executable instructions to perform the following operations:

extracting a plurality of first target terms and one or more adjacent term combinations of each first target term from a to-be-learned text set; respectively encoding each first target term and each adjacent term combination according to a word bank of the to-be-learned text set; obtaining a capsule network model by training by taking the encoding of each first target term as an input vector and the encoding of each adjacent term combination corresponding to each first target term as an output vector; when a to-be-recognized second target term is recognized, inputting the second target term into the capsule network model, and determining a plurality of obtained intermediate vectors as feature vectors of the second target term; and clustering the feature vectors with a cosine similarity greater than a similarity threshold to generate representative terms of one or more categories to which the feature vectors of the second target term belong, and determining one or more meanings of the second target term according to the representative terms of one or more categories to which the feature vectors of the second target term belong.

It is to be understood that the foregoing general description and the following detailed description are merely for illustration and explanation purposes and are not intended to limit the present disclosure.

### BRIEF DESCRIPTION OF THE DRAWINGS

The accompanying drawings herein are included in the specification and form a part of the specification, illustrate embodiments consistent with the present disclosure, and serve to explain the principles of the present disclosure together with the description. Obviously, the accompanying drawings in the following description are merely some embodiments of the present disclosure. For a person of ordinary skill in the art, other accompanying drawings can be obtained based on the accompanying drawings without creative efforts.

FIG. 1 schematically illustrates a schematic diagram of a meaning learning model in the related art;

FIG. 2 schematically illustrates a flowchart of a polysemant meaning learning method according to an exemplary embodiment;

FIG. 3 schematically illustrates a schematic diagram of a capsule network model for polysemant meaning learning according to an exemplary embodiment;

FIG. 4 schematically illustrates a scenario to which a capsule network model is applied according to an exemplary embodiment;

FIG. 5 schematically illustrates a sub-flow chart of a polysemant meaning learning method according to an exemplary embodiment;

FIG. 6 schematically illustrates a flowchart of a polysemant meaning learning method according to an exemplary embodiment;

FIG. 7 schematically illustrates a scenario to which a search result display method is applied according to an exemplary embodiment;

FIG. 8 schematically illustrates a schematic diagram of another scenario to which a search result display method is applied according to an exemplary embodiment;

FIG. 9 schematically illustrates a flowchart of a meaning-recognition-based search result display method according to an exemplary embodiment;

FIG. 10 schematically illustrates a structural block diagram of a polysemant meaning learning apparatus according to an exemplary embodiment;

FIG. 11 schematically illustrates a structural block diagram of a meaning-recognition-based search result display apparatus according to an exemplary embodiment;

FIG. 12 schematically illustrates an electronic device for implementing the foregoing method according to an exemplary embodiment; and

FIG. 13 schematically illustrates a computer-readable storage medium or implementing the foregoing method according to an exemplary embodiment.

### DETAILED DESCRIPTION

Exemplary implementations will now be described more thoroughly with reference to the accompanying drawings. However, the exemplary implementations can be implemented in various forms and should not be construed as being limited to the examples set forth herein. Rather, the implementations are provided so that the present disclosure can be more comprehensive and complete, and the concepts of the exemplary implementations are fully conveyed to a person skilled in the art. The described features, structures, or characteristics are combined in one or more implementations in any appropriate manner.

Text recognition methods of related arts have great limitations in polysemant recognition. For example, a Word2vec (a group of related models for generating term vector) tool learns meanings based on a specific corpus, but can learn only a corresponding term vector for each term, and thus cannot distinguish a plurality of meanings of a polysemant. As a result, the polysemant is misunderstood, and the accuracy of a plurality of services is affected.

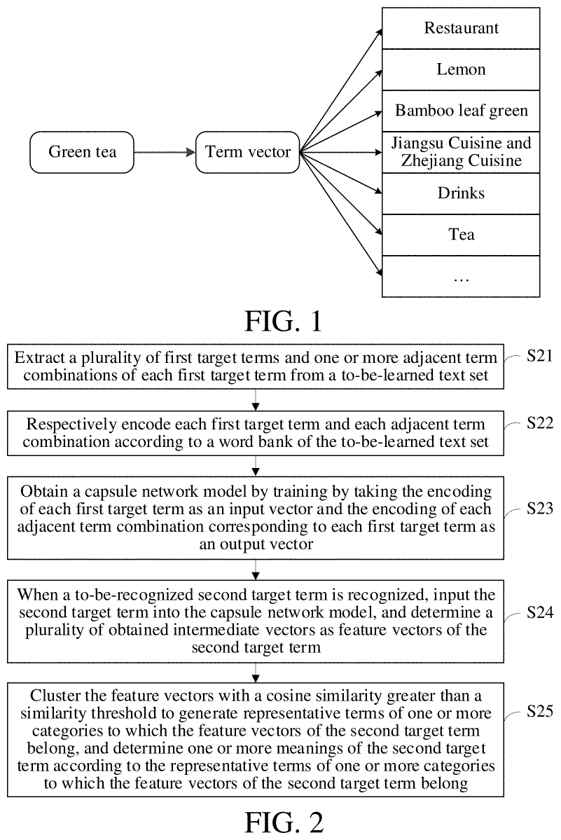

In one solution of the related art, meaning learning is implemented by giving an input term, predicting adjacent terms in a context and obtaining an intermediate term vector by training. Referring to FIG. 1, in a scenario of food search and review, through corpus statistics, terms that appear more frequently next to “green tea” are “restaurant”, “lemon”, “bamboo leaf green”. A Skip-gram model (a neural network model for meaning learning) is constructed, which takes “green tea” as input, trains intermediate weight parameters, and makes output the adjacent terms such as “restaurant”, “lemon”, and “bamboo leaf green”, and an obtained intermediate vector is a term vector of “green tea”. However, the adjacent terms such as “restaurant”, “lemon”, and “bamboo leaf green” correspond to different meanings of “green tea”. For example, the term “green tea” refers to a kind of tea, and adjacent terms thereof are “bamboo leaf green”, “tea”, and the like; or “Green tea” refers to a restaurant name, and adjacent terms thereof are “restaurant”, “Jiangsu Cuisine and Zhejiang Cuisine”, and the like; or “Green tea” refers to a type of drink, and adjacent terms thereof are “lemon”, “drinks”, and the like. With model processing in FIG. 1, no matter which meaning the adjacent terms correspond to, the resulting term vector of “green tea” is the same. It can be seen that the solution cannot be used in scenarios of polysemy, which may lead to misunderstanding of polysemant meanings.

An exemplary embodiment of the present disclosure provides a polysemant meaning learning method. Referring to FIG. 2, the method includes the following steps S21 to S25:

Step S21. Extract a plurality of first target terms and one or more adjacent term combinations of each first target term from a to-be-learned text set.

The to-be-learned text set may be regarded as a corpus, including a large number of to-be-learned texts. The first target terms are to-be-learned terms in the to-be-learned texts. Moreover, the first target terms are a part of terms in the to-be-learned texts, or all terms in the to-be-learned texts. The polysemant meanings in this embodiment are richer than the polysemants in the Chinese dictionary. Meanings are combined with corpus characteristics of an application scenario, and results of meaning differentiation are generally more refined. Taking the scenario of food search and review as an example, the term “green tea” refers to a kind of tea, a restaurant name, or a type of drink, but may refer to only one kind of tea in the Chinese dictionary. It can be seen that in a particular corpus, the meanings commonly known by people are not sufficient. Therefore, meaning learning can be performed on all terms, and all terms in a to-be-learned text set are the first target terms. The adjacent term combination refers to a combination of two or more terms that often appear in groups with a first target term in the to-be-learned text set, that is, one adjacent term combination of the first target term. In the to-be-learned text set, the first target term may generally be used in conjunction with more than one adjacent term combination. In this embodiment, all adjacent term combinations of each first target term are extracted. Each adjacent term combination includes at least two terms. An upper limit of a quantity of terms is not particularly limited.

Step S22. Respectively encode each first target term and each adjacent term combination according to a word bank of the to-be-learned text set.

The word bank of the to-be-learned text set includes at least a part of terms or all terms in the to-be-learned text set, and further includes the number of each term or correlation information between each term and other terms.

When the word bank of the to-be-learned text set further includes the number of each term, the step of respectively encoding each first target term and each adjacent term combination according to a word bank of the to-be-learned text set is: encoding, based on a word bank including term numbers, the first target term and the adjacent term combination by one-hot coding. For example, if a quantity of terms in the word bank is 10,000, the first target terms can be encoded into 10,000-dimensional vectors, where the first target terms correspond to a dimension value of 1, and other dimension values are 0. The adjacent term combinations may also be encoded into 10000-dimensional vectors, where a dimension value corresponding to each adjacent term is 1, and other dimension values are 0.

When the word bank of the to-be-learned text set further includes correlation information between each term and other terms, the step of respectively encoding each first target term and each adjacent term combination according to a word bank of the to-be-learned text set is: encoding, based on a word bank including term correlation information, the first target term and the adjacent term combination by Word2vec term vector coding. The first target term corresponds to a term vector. The adjacent term combination corresponds to a matrix including a plurality of term vectors. This embodiment does not specifically limit the manner of encoding.

Step S23. Obtain a capsule network model by training by taking the encoding of each first target term as an input vector and the encoding of each adjacent term combination corresponding to each first target term as an output vector.

The capsule network model is an improved neural network model, in which each neuron represents a multi-dimensional vector. The capsule network model is similar to a general neural network model in terms of parameter types. The difference is that the capsule network model includes a special intermediate layer that is referred to as a routing layer. During transformation to the routing layer, in addition to the setting of a weight coefficient of each neuron, a coupling coefficient of each neuron is also set. In a previous layer of the routing layer, each neuron represents feature vectors of the first target term that are extracted according to different meaning features. An adjacent term combination of the first target term generally corresponds to a meaning of the first target term. Therefore, during processing of the routing layer, degrees of coupling between the neurons representing different meanings and outputted adjacent term combinations are different, and a coupling coefficient reflects a relationship between such degrees of coupling.

Through training, weight coefficients and coupling coefficients of the capsule network model can be optimized and adjusted, to obtain a trained capsule network model.

Step S24. When a to-be-recognized second target term is recognized, input the second target term into the capsule network model, and determine a plurality of obtained intermediate vectors as feature vectors of the second target term.

The plurality of intermediate vectors refer to vectors corresponding to a plurality of neurons in a specific intermediate layer, rather than vectors of a plurality of intermediate layers. The intermediate layer is the previous layer of the routing layer described above, and this embodiment does not particularly limit the position of the intermediate layer in the capsule network model layer.

Step S25. Cluster the feature vectors with a cosine similarity greater than a similarity threshold to generate representative terms of one or more categories to which the feature vectors of the second target term belong, and determine one or more meanings of the second target term according to the representative terms of the one or more categories to which the feature vectors of the second target term belong.

Clustering can make similar feature vectors form a category, and is implemented in a specific manner such as K-Means (a k-means clustering algorithm). After the clustering is completed, an average feature vector or a mode feature vector is extracted from each category, and a target term corresponding to the average feature vector or a target term corresponding to the mode feature vector is taken as a representative term of the category; or a representative term of each category is determined by matching through a preset category word bank. The representative term may represent a meaning of the category to which the feature vectors of the second target term belong. Therefore, if the feature vectors of the second target term belong to a plurality of categories, the second target term has meanings of representative terms of the categories, thereby learning a plurality of meanings for the second target term. It is to be noted that among the feature vectors of the second target term, two or more feature vectors may belong to the same category. Therefore, a quantity of categories covered by the second target term and a quantity of the feature vectors are not necessarily the same. Even all the feature vectors of the second target term may belong to the same category, and it is determined that the second target term has only one meaning.

Based on the foregoing description, in this exemplary embodiment, a capsule network model is trained based on encoding of a first target term and adjacent term combinations in a to-be-learned text set, then the first target term is processed by using the trained capsule network model, to obtain feature vectors of the first target term, and finally the feature vectors of the first target term are clustered, to determine one or more meanings of the first target term according to a representative term of a category to which the first target term belongs. On the one hand, this exemplary embodiment provides an effective polysemant meaning learning method, which can implement multi-meaning recognition on a target term for an unlabeled to-be-learned text set, and has strong universality. Moreover, the implementation of the method requires a lower labor cost. On the other hand, based on a learned meaning of a first target term, in the application, a plurality of results of meaning recognition on a text including the first target term can be generated, different meanings of the first target term in different contexts can be distinguished, and the accuracy of text recognition is improved.

In an exemplary embodiment, the intermediate vectors in step S24 are first intermediate vectors, and the capsule network model may include at least:

an input layer, configured to input P-dimensional input vectors;

an intermediate layer, configured to convert the input vectors into M N-dimensional first intermediate vectors;

a routing layer, configured to convert the first intermediate vectors into P-dimensional second intermediate vectors; and

an output layer, configured to convert the second intermediate vectors into P-dimensional output vectors.

P is a quantity of terms in the word bank of the to-be-learned text set, which represents that the word bank includes P terms in total. M is a preset maximum quantity of meanings, which represents that among all the first target terms, a quantity of meanings the first target term with the most meanings has is no more than M. N is a preset quantity of features, which represents that each first target term is identified by N features.

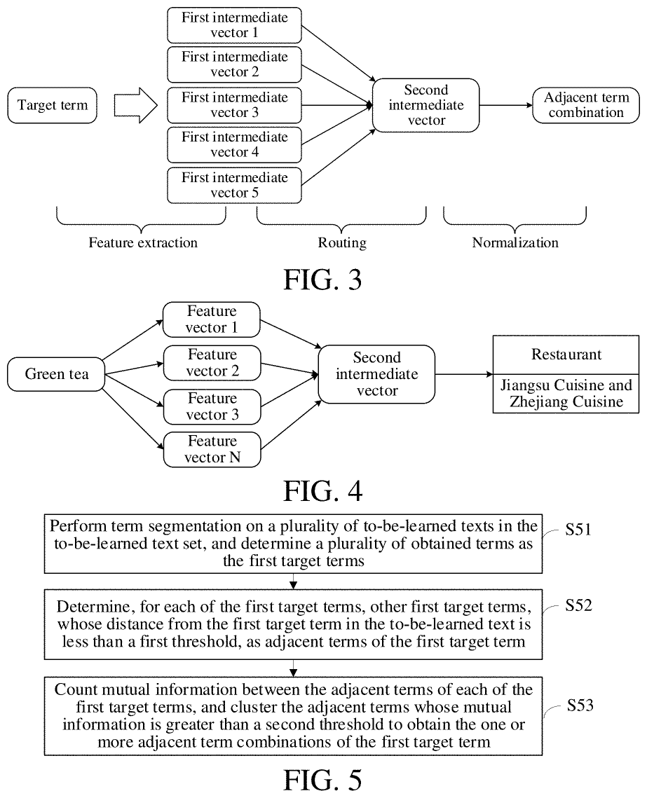

FIG. 3 illustrates an example of the capsule network model. A second target term is inputted into the capsule network model, and a plurality of first intermediate vectors are generated through feature extraction of a first weight coefficient. FIG. 3 illustrates that the preset maximum quantity M of meanings is 5. Certainly, this embodiment is not limited thereto. The first intermediate vectors are calculated by routing a second weight coefficient and a coupling coefficient to obtain second intermediate vectors. The first intermediate vectors and the second intermediate vectors are both neuron capsules in a form of vectors. Finally, the second intermediate vectors are normalized to obtain an output vector, that is, encoding of an adjacent term combination.

FIG. 4 illustrates a schematic diagram of a scenario in which the capsule network model of FIG. 3 is applied to food search and review. The capsule network model recognizes “green tea” to predict an adjacent term combination of “green tea”. A plurality of adjacent term combinations of “green tea” can be obtained by adjusting a coupling coefficient. For example, in one coupling coefficient, the adjacent term combinations outputted by the model are “restaurant” and “Jiangsu Cuisine and Zhejiang Cuisine”. In another coupling coefficient, the adjacent term combinations outputted by the model are “lemon”, “drink”, and the like.

Based on the foregoing capsule network model, each first target term is inputted into the capsule network model, and the obtained M N-dimensional first intermediate vectors are determined as feature vectors of the first target term. For example, after the capsule network model shown in FIG. 3 is trained, when the second target term is recognized, the second target term is inputted into the capsule network model, and obtained five first intermediate vectors are five feature vectors of the first target term. Further, an input layer and an intermediate layer are extracted from the trained capsule network model, and in the step of acquiring feature vectors, the inputted second target term is processed only through the two layers, which can reduce the amount of calculation.

In an exemplary embodiment, referring to FIG. 5, the extracting a plurality of first target terms and one or more adjacent term combinations of each first target term from a to-be-learned text set is implemented through the following steps S51 to S53:

Step S51. Perform term segmentation on a plurality of to-be-learned texts in the to-be-learned text set, and determine a plurality of obtained terms as the first target terms.

In this step, term segmentation is performed on a part of to-be-learned texts in the to-be-learned text set to obtain the plurality first target terms, or term segmentation is performed on all to-be-learned texts in the to-be-learned text set to obtain the plurality first target terms. Moreover, after term segmentation is performed on the to-be-learned texts, terms obtained are used as the first target terms, or terms with a designated part of speech in the obtained terms are filtered, and the remaining terms are used as the first target terms. The designated part of speech is at least one of a particle, a numeral, an adverb, an article, a preposition, a conjunction, and an interjection.

In this embodiment of the present disclosure, terms obtained from the term segmentation on the to-be-learned texts are used as the first target terms, thereby improving the coverage of the first target terms and improving the accuracy of the subsequently trained capsule network model. The terms with the designated part of speech in the terms obtained from the term segmentation on the to-be-learned texts are filtered, and the remaining terms are used as the first target terms, thereby reducing the amount of calculation and improving the efficiency.

Step S52. Determine, for each of the first target terms, other first target terms, whose distance from the first target term in the to-be-learned text is less than a first threshold, as adjacent terms of the first target term.

Step S53. Count mutual information between the adjacent terms of each of the first target terms, and cluster the adjacent terms whose mutual information is greater than a second threshold to obtain the one or more adjacent term combinations.

The first threshold may be regarded as a size of a term extraction window of adjacent terms. For example, when the first threshold is 5, the adjacent terms can be obtained by sliding the term extraction window of a size of 5 terms on left and right sides of the first target terms in the to-be-learned text. The second threshold is a threshold for determining whether the adjacent terms of the first target term belong to the same category. When the mutual information between two or more adjacent terms is greater than the second threshold, it indicates that between the adjacent terms are highly correlated and can be classified into one adjacent term combination. It is to be noted that mutual information between each adjacent term in the adjacent term combination and any other adjacent term in the combination is set to be greater than the second threshold, or mutual information between each adjacent term and all other adjacent terms in the combination needs to be greater than the second threshold, or other clustering conditions is set.

In other embodiments, the adjacent terms of the first target term can also form other adjacent term combinations in other clustering manners, and this exemplary implemented is not limited thereto.

Further, step S52 is implemented through the following steps:

For each of the first target terms, other first target terms, whose distance from the first target term in the to-be-learned text is less than the first threshold, are determined as quasi-adjacent terms of the first target term.

Mutual information between each of the quasi-adjacent terms and the first target term is counted, and the quasi-adjacent terms with mutual information between the quasi-adjacent terms and the first target term greater than a third threshold are determined as the adjacent terms of the first target term.

That is, during the counting, the adjacent terms, in addition to needing to be adjacent to the first target term in the to-be-learned texts, need also to be highly correlated with the first target term, which is reflected in the need that mutual information with the first target term is greater than a third threshold. The third threshold may be set according to an actual situation. For example, when the to-be-learned text set is larger and a quantity of quasi-adjacent terms of the first target term is larger, the third threshold is set to a larger value. Conversely, the third threshold is set to a smaller value, which is not particularly limited in this embodiment. Through the above steps, the adjacent terms of the first target term are simplified, which can further reduce the amount calculation during learning.

In an exemplary embodiment, the word bank of the to-be-learned text set is constructed by using all the first target terms of the to-be-learned text set. All the first target terms in the to-be-learned text set form the word bank of the to-be-learned text set, or a part of the first target terms in the to-be-learned text set forms the word bank of the to-be-learned text set. When a part of the first target terms in the to-be-learned text set forms the word bank of the to-be-learned text set, terms with a designated part of speech in all the first target terms in the to-be-learned text set are filtered, and the remaining first target terms form the word bank of the to-be-learned text set.

In this embodiment of the present disclosure, all terms obtained from the term segmentation on the to-be-learned text set are appropriately filtered to remove structural terms or modal particle that have no practical meaning, such as “ [symbol] ” (a Chinese character indicating something belongs”, “ [symbol] ” (a Chinese character indicating modal) and “ [symbol] ” (a Chinese character indicating politeness). The rest are the first target terms that form the word bank of the to-be-learned text set. In addition, each first target term in the word bank of the to-be-learned text set is assigned a unique number, or correlated information between the first target terms is counted and recorded as one or more dimensional information. This embodiment does not limit the type of information included in the word bank.

In an exemplary embodiment, the clustering similar feature vectors is implemented through the following step: counting a cosine similarity between each two of the feature vectors, and clustering the feature vectors with the cosine similarity greater than the similarity threshold into one category. The similarity threshold refers to a critical value for determining whether two feature vectors can be clustered. For example, when the cosine similarity between two feature vectors is greater than the similarity threshold, it indicates that the two feature vectors are similar and can be classified into the same category. Clustering is determined by calculating the cosine similarity, so that a degree of coincidence between two feature vectors can be recognized in a high-dimensional space of the feature vectors, the judgment result is more accurate, and the final clustering is of higher quality.

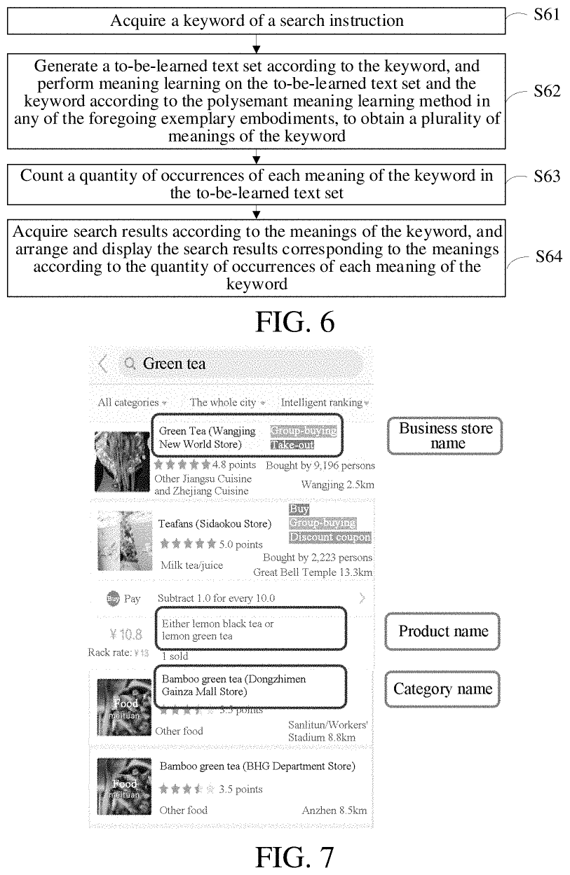

An exemplary embodiment of the present disclosure further provides a meaning-recognition-based search result display method. Referring to FIG. 6, the method includes the following steps:

Step S61. Acquire a keyword of a search instruction.

Step S62. Generate a to-be-learned text set according to the keyword, and perform meaning learning on the to-be-learned text set and the keyword according to the polysemant meaning learning method in any of the foregoing exemplary embodiments, to obtain a plurality of meanings of the keyword.

According to the keywords, the corpus set of a service section to which the keyword belongs is obtained, and the corpus set is taken as the to-be-learned text set.

Step S63. Count a quantity of occurrences of each meaning of the keyword in the to-be-learned text set.

Step S64. Acquire search results according to the meanings of the keyword, and arrange and display the search results corresponding to the meanings according to the quantity of occurrences of each meaning of the keyword.

The to-be-learned text set generated according to the keyword is a corpus set of a service section to which the keyword belongs. For example, in a case of a search for food and restaurants, the to-be-learned text set is historical search texts and review texts of food and restaurant sections. FIG. 7 illustrates a schematic effect diagram of a scenario in which the method according to this embodiment is applied to a search for food and restaurants. As shown in FIG. 7, when a user searches for “green tea”, according to the learning of the to-be-learned text set, three meanings of “green tea” are obtained, which are respectively a business store name, a product name, and a category name. Moreover, according to statistical results, the term “business store name” appears most frequently, followed by the product name, and the category name appears least frequently. Therefore, when search results of “green tea” are displayed, “green tea” is recognized as the search result corresponding to the business store name and is displayed at the top.

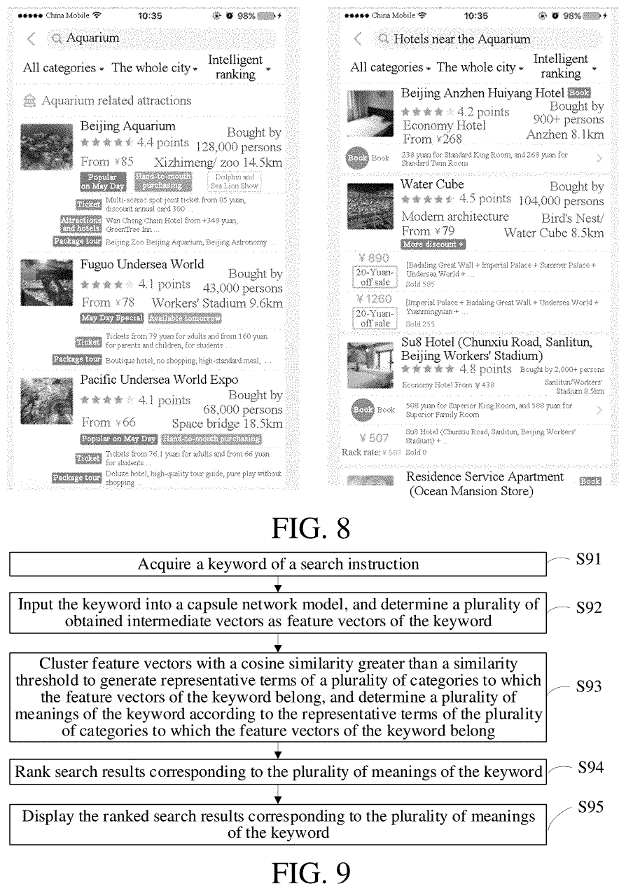

In an exemplary embodiment, search results corresponding to the meanings are arranged according to a user intention or context information of a search keyword. Referring to FIG. 8, when a user searches for “aquarium”, according to a current application scenario, the user may learn that “aquarium” has a plurality of meanings, which is a scenic spot or an address. When the user searches for the terms “ticket” and “time” in a context of “aquarium”, it can be known that the user intends to search for a scenic spot, and “aquarium” can be displayed as a search result of the scenic spot. When the context of “aquarium” inputted by the user includes “nearby”, “hotel”, and other terms, it can be known that the user intends to search for an address, and “aquarium” can be displayed as a search result of the address. Therefore, the search results are displayed according to different user intentions, so as to meet diversified search needs of users.

An exemplary embodiment of the present disclosure further provides a meaning-recognition-based search result display method. The method is applied to an electronic device. Referring to FIG. 9, the method includes the following steps:

Step S91. Acquire a keyword of a search instruction.

A search application is installed on the electronic device. A user uses the search application on the electronic device to conduct a search. The search application is a map application, a browser, or a shopping application. The search instruction includes at least a keyword, and also includes context information of the keyword.

For example, when the user uses the search application on the electronic device to search for “aquarium”, the user inputs only “aquarium”. In this case, the electronic device acquires the search instruction, and the search instruction carries only “aquarium”.

In another example, when the user uses the search application on the electronic device to search for a business named “aquarium”, the user inputs “aquarium” and “business”. In this case, the electronic device acquires the search instruction. In addition to the keyword “aquarium”, the search instruction also carries context information “business”.

In another example, when the user uses the search application on the electronic device to search for a scenic spot named “aquarium”, the user inputs “aquarium” and “ticket” or the user inputs “aquarium” and “time”. In this case, the electronic device acquires the search instruction. In addition to the keyword “aquarium”, the search instruction also carries context information “ticket” or “time”.

In another example, when the user uses the search application on the electronic device to search for an address named “aquarium”, the user inputs “aquarium” and “hotel” or the user inputs “aquarium” and “nearby”. In this case, the electronic device acquires the search instruction. In addition to the keyword “aquarium”, the search instruction also carries context information “hotel” or “nearby”.

Step S92. Input the keyword into a capsule network model, and determine a plurality of obtained intermediate vectors as feature vectors of the keyword.

It is to be noted that when the keyword is inputted into the capsule network model, a plurality of intermediate vectors are outputted, and the plurality of intermediate vectors are determined as a plurality of feature vectors of the keyword. In addition, the capsule network model is trained for the electronic device, or is trained for other devices and stored in the electronic device. Moreover, the training process of the capsule network model is the same as steps S21 to S24, and is not described in detail herein.

Step S93. Cluster feature vectors with a cosine similarity greater than a similarity threshold to generate representative terms of one or more categories to which the feature vectors of the second target term belong, and determine a plurality of meanings of the keyword according to the representative terms of a plurality of categories to which the feature vectors of the keyword belong.

This step is similar to step S25, and is not described in detail herein. For example, the electronic device identifies the keyword “aquarium” and obtains three meanings of “aquarium”, which are respectively “business”, “scenic spot”, and “address”.

Step S94. Rank search results corresponding to the plurality of meanings of the keyword.

In a first implementation, the plurality of meanings are in a default order, and search results corresponding to the plurality of meanings are ranked according to the default order. Correspondingly, this step is: acquiring a default order of the plurality of meanings, and the search results corresponding to the plurality of meanings of the keyword are ranked according to the default order of the plurality of meanings.

For example, the default order of the three meanings “business”, “scenic spot”, and “address” of “aquarium” is “business”, “scenic spot”, and “address”, so search results corresponding to the plurality of meanings are in order of the search result corresponding to “merchant”, the search result corresponding to “scenic spot”, and the search result corresponding to “address”.

In this embodiment of the present disclosure, the search results corresponding to the plurality of meanings are directly ranked according to the default order of the plurality of meanings, thereby improving the efficiency.

In a second implementation, according to a historical search record, a search intention of the user is analyzed. Correspondingly, this step is: acquiring a first historical search record of a current user; determining a first search intention of the current user based on the first historical search record; and ranking, according to the first search intention, the search results corresponding to the plurality of meanings of the keyword.

The first historical search record is a search record within a preset time period before the current time. Moreover, the first historical search record includes a plurality of keywords. Types of the plurality of keywords are determined, and the first search intention of the current user is determined according to the types of the plurality of keywords. For example, the first historical search record includes three keywords, which are respectively “travel”, “self-driving tour”, and “fun place”, so the first search intention of the current user is determined as “travel” according to the first historical search record.

When the first search intention of the current user is determined, a first correlation between each meaning and the first search intention is determined according to the plurality of meanings, and search results corresponding to the meanings are ranked in descending order of the first correlations. The search result corresponding to the meaning having the highest first correlation with the first search intention is ranked first, and the search result corresponding to the meaning with the least first correlation with the first search intention is ranked last.

For example, if the first search intention of the current user is determined as “travel”, the first correlations between “business”, “scenic spot”, “address” and the first search intention are in descending order of “scenic spot”, “address”, and “business”, and search results corresponding to the plurality of meanings are in order of the search result corresponding to “scenic spot”, the search result corresponding to “address”, and the search result corresponding to “merchant”.

In this embodiment of the present disclosure, the first search intention is determined according to the first historical search record of the current user, so that the search intention of the current user is added to search ranking to rank search results of meanings corresponding to the search intention of the current user ahead, thereby improving the accuracy.

In a third implementation, a search intention of a current user is analyzed according to context information of the keyword. Correspondingly, this step is: acquiring context information of the keyword, determining a second search intention of the current user according to the context information, and ranking, according to the second search intention, the search results corresponding to the plurality of meanings of the keyword.

In addition to the keyword, the search instruction also includes context information of the keyword. Correspondingly, the context information of the keyword is acquired from the search instruction. Correspondingly, the step of determining a second search intention of the current user according to the context information is: determining a search intention corresponding to the context according to the context information, and determining the search intention corresponding to the context as the second search intention of the current user. For example, when the context information is “ticket” or “time”, the second search intention of the current user is determined as “tourist attraction”. In another example, when the context information is a term such as “nearby” or “hotel”, the second search intention of the current user is determined as “address”.

It is to be noted that the process of ranking, according to the second search intention, the search results corresponding to the plurality of meanings of the keyword is similar to the process of ranking, according to the first search intention, the search results corresponding to the plurality of meanings of the keyword, and is not described in detail herein.

In this embodiment of the present disclosure, the second search intention is determined according to the context information of the keyword, so that the second search intention of the current user is added to search ranking to rank search results of meanings corresponding to the second search intention of the current user ahead, thereby improving the accuracy and meeting a user search need.

In a fourth implementation, a search intention of a current user is determined with the aid of historical search records of others. Correspondingly, this step is: acquiring second historical search records of a plurality of users, determining search popularity of the plurality of meanings according to the second historical search records of the plurality of users, and ranking, according to the search popularity of the plurality of meanings, the search results corresponding to the plurality of meanings of the keyword.

The search popularity is a quantity of searches or frequency of searches. In this embodiment of the present disclosure, the search popularity of the plurality of meanings is determined according to the second historical search records of other users, and the meaning with the highest search popularity is determined as a third search intention of the current user, so that the search result of the meaning with the highest search popularity is ranked ahead, thereby improving the accuracy.

It is to be noted that the search results corresponding to the plurality of meanings of the keyword are ranked in any one of the first to fourth implementations, or it is first determined whether the search instruction includes context information of the keyword. When the context information of the keyword is not included, the search results corresponding to the plurality of meanings of the keyword are ranked in the foregoing first, second, or fourth implementation. When the context information of the keyword is included, the search results corresponding to the plurality of meanings of the keyword are ranked in the foregoing third implementation.

Step S95. Display the ranked search results corresponding to the plurality of meanings of the keyword.

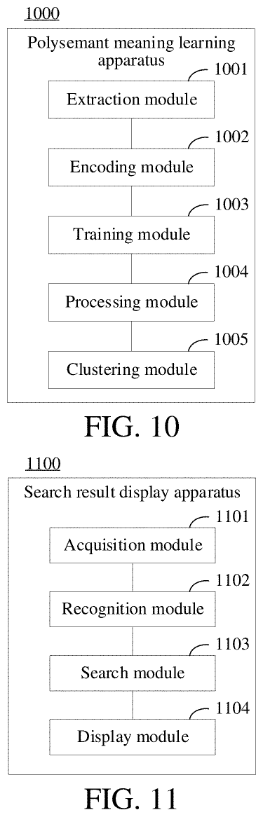

An exemplary embodiment of the present disclosure further provides a polysemant meaning learning apparatus based on a capsule network model. Referring to FIG. 10, the apparatus 1000 includes:

an extraction module 1001, configured to extract a plurality of first target terms and one or more adjacent term combinations of each first target term from a to-be-learned text set;

an encoding module 1002, configured to respectively encode each first target term and each adjacent term combination according to a word bank of the to-be-learned text set;

a training module 1003, configured to obtain a capsule network model by training by taking the encoding of each first target term as an input vector and the encoding of each adjacent term combination corresponding to each first target term as an output vector;

a processing module 1004, configured to, when a to-be-recognized second target term is recognized, input the second target term into the capsule network model, and determine a plurality of obtained intermediate vectors as feature vectors of the second target term; and

a clustering module 1005, configured to cluster the feature vectors with a cosine similarity greater than a similarity threshold to generate representative terms of one or more categories to which the feature vectors of the second target term belong, and determine one or more meanings of the second target term according to the representative terms of one or more categories to which the feature vectors of the second target term belong.

In an exemplary embodiment of the present disclosure, the intermediate vectors are first intermediate vectors, and the capsule network model includes at least: an input layer, configured to input P-dimensional input vectors; an intermediate layer, configured to convert the input vectors into M N-dimensional first intermediate vectors; a routing layer, configured to convert the first intermediate vectors into P-dimensional second intermediate vectors; and an output layer, configured to convert the second intermediate vectors into P-dimensional output vectors. P is a quantity of terms in the word bank of the to-be-learned text set, M is a preset maximum quantity of meanings, and N is a preset quantity of features.

In an exemplary embodiment of the present disclosure, the extraction module 1001 is further configured to perform term segmentation on a plurality of to-be-learned texts in the to-be-learned text set, and determine a plurality of obtained terms as the first target terms; determine, for each of the first target terms, other first target terms, whose distance from the first target term in the to-be-learned text is less than a first threshold, as adjacent terms of the first target term; and count mutual information between the adjacent terms of each of the first target terms, and cluster the adjacent terms whose mutual information is greater than a second threshold to obtain the one or more adjacent term combinations of the first target term.

In an exemplary embodiment of the present disclosure, the extraction module 1001 is further configured to determine, for each of the first target terms, other first target terms, whose distance from the first target term in the to-be-learned text is less than the first threshold, as quasi-adjacent terms of the first target term; and count mutual information between each of the quasi-adjacent terms and the first target term, and determine the quasi-adjacent terms with mutual information between the quasi-adjacent terms and the first target term greater than a third threshold as the adjacent terms of the first target term.

In an exemplary embodiment of the present disclosure, the apparatus further includes: a construction module, configured to construct the word bank of the to-be-learned text set by using the plurality of the first target terms of the to-be-learned text set.

In an exemplary embodiment of the present disclosure, the clustering module 1002 is further configured to count a cosine similarity between each two of the feature vectors, and cluster the feature vectors with the cosine similarity greater than the similarity threshold into one category.

Specific details of each module have been described in detail in the embodiments of the method section, and therefore are not described in detail.

A person skilled in the art may understand that the aspects of the present disclosure are implemented as systems, methods, or program products. Therefore, various aspects of the present disclosure are implemented in the following forms, that is, a hardware-only implementation, a software-only implementation (including firmware, microcode, and the like), or an implementation of a combination of hardware and software, which is collectively referred to as a “circuit”, “module”, or “system” herein.

An exemplary embodiment of the present disclosure further provides a meaning-recognition-based search result display apparatus. Referring to FIG. 11, the apparatus 1100 includes:

an acquisition module 1101, configured to acquire a keyword of a search instruction;

a recognition module 1102, configured to input the keyword into a capsule network model, and determine a plurality of obtained intermediate vectors as feature vectors of the keyword; and cluster feature vectors with a cosine similarity greater than a similarity threshold to generate representative terms of one or more categories to which the feature vectors of the second target term belong, and determine a plurality of meanings of the keyword according to the representative terms of a plurality of categories to which the feature vectors of the keyword belong;

a search module 1103, configured to acquire a search result according to the plurality of meanings of the keyword; and

a display module 1104, configured to rank search results corresponding to the plurality of meanings of the keyword, and display the ranked search results corresponding to the plurality of meanings of the keyword.

In an exemplary embodiment of the present disclosure, the display module 1104 is further configured to acquire a first historical search record of a current user, determine a first search intention of the current user based on the first historical search record, and rank, according to the first search intention, the search results corresponding to the plurality of meanings of the keyword.

In an exemplary embodiment of the present disclosure, the display module 1104 is further configured to acquire context information of the keyword, determine a second search intention of the current user according to the context information, and rank, according to the second search intention, the search results corresponding to the plurality of meanings of the keyword.

In an exemplary embodiment of the present disclosure, the display module 1104 is further configured to acquire second historical search records of a plurality of users, determine search popularity of the plurality of meanings according to the second historical search records of the plurality of users, and rank, according to the search popularity of the plurality of meanings, the search results corresponding to the plurality of meanings of the keyword.

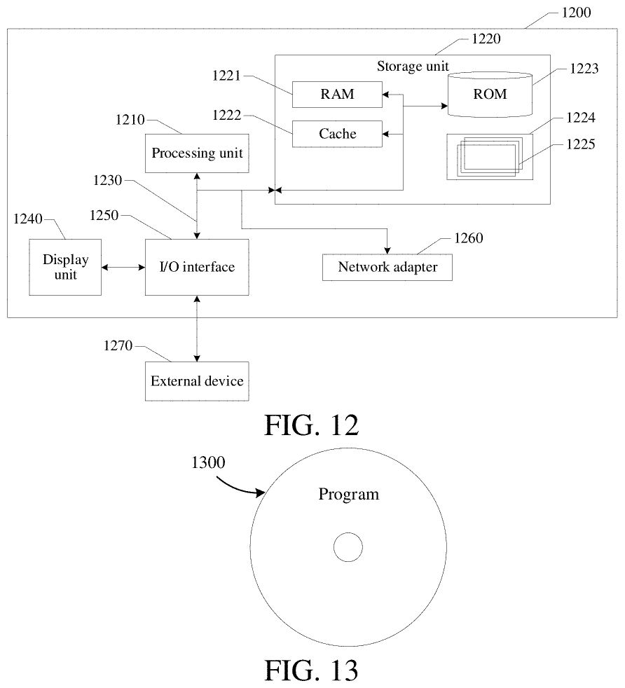

An exemplary embodiment of the present disclosure further provides an electronic device that can implement the foregoing methods. The electronic device 1200 according to this exemplary embodiment of the present disclosure is described below with reference to FIG. 12. The electronic device 1200 shown in FIG. 12 is only an example, and does not impose any limitation on the functions and the scope of use of the exemplary embodiments of the present disclosure.

As shown in FIG. 12, the electronic device 1200 is represented in the form of a general-purpose computing device. Components of the electronic device 1200 include, but are not limited to: at least one processing unit 1210, at least one storage unit 1220, a bus 1230 connecting different system components (including the storage unit 1220 and the processing unit 1210), and a display unit 1240.

The storage unit stores program code, and the program code is executed by the processing unit 1210 to cause the processing unit 1210 to perform the steps according to various exemplary implementations of the present disclosure described in the foregoing “exemplary methods” of this specification. For example, the processing unit 1210 performs steps S21 to S25 shown in FIG. 2, or performs steps S51 to S53 shown in FIG. 5, or performs steps S61 to S64 shown in FIG. 6, or performs steps S91 to S95 shown in FIG. 9, or the like.

The storage unit 1220 includes a readable medium in the form of a volatile storage unit, for example, a random access memory (RAM) 1221 and/or a cache storage unit 1222, and further includes a read-only memory (ROM) 1223.

The storage unit 1220 further includes a program/utility tool 1224 including a group of (at least one) program modules 1225, and such program modules 1225 include, but are not limited to, an operating system, one or more application programs, other program modules, and program data. Each or certain combination of the examples may include implementation of a network environment.

The bus 1230 is one or more of several types of bus structures, including a storage unit bus or a storage unit 1220, a controller, a peripheral bus, a graphics acceleration port, a processing unit 1210, or a local bus using any of various bus structures.

The electronic device 1200 can also communicate with one or more external devices 1270 (for example, a keyboard, a pointing device, a Bluetooth device, and the like), and can also communicate with one or more devices that enable a user to interact with the electronic device 1200, and/or communicate with any device (for example, a router, a modem, and the like) that enables the electronic device 1200 to communicate with one or more other computing devices. This communication proceeds through an input/output (I/O) interface 1250. Moreover, the electronic device 1200 also communicates with one or more networks (for example, a local area network (LAN), a wide area network (WAN) and/or a public network such as the Internet) through a network adapter 1260. As shown in the figure, the network adapter 1260 communicates with other modules of the electronic device 1200 through the bus 1230. It is to be understood that although not shown in the figure, other hardware and/or software modules can be used in conjunction with the electronic device 1200, including, but not limited to, microcode, a device driver, a redundancy processing unit, an external magnetic disk driving array, a redundant array of independent disks (RAID) system, a magnetic tape drive, a data backup storage system, and the like.

According to the foregoing descriptions of the implementations, a person skilled in the art may readily understand that the exemplary implementations described herein are implemented by using software, or are implemented by combining software and necessary hardware. Therefore, the technical solutions according to the implementations of the present disclosure are embodied in the form of a software product. The software product is stored in a non-volatile storage medium (for example, a CD-ROM, a USB flash drive, or the like) or on a network and includes several instructions for instructing a computing device (for example, a personal computer, a server, a terminal apparatus, a network device, or the like) to perform the methods according to the exemplary embodiments of the present disclosure.

An exemplary embodiment of the present disclosure further provides a computer-readable storage medium storing a program product that can implement the foregoing methods in this specification. In some possible implementations, various aspects of the present disclosure can also be implemented in the form of a program product, which includes program code. When the program product is run on a terminal device, the program code is used for causing the terminal device to perform the steps according to various exemplary implementations of the present disclosure described in the foregoing “exemplary methods” of this specification.

Referring to FIG. 13, a program product 1300 for implementing the foregoing methods according to an exemplary embodiment of the present disclosure is described. The program product may use a portable compact disk read-only memory (CD-ROM) and include program code, and can be run on a terminal device, such as a personal computer. However, the program product of the present disclosure is not limited to this. In the present specification, the readable storage medium is any tangible medium including or storing a program, and the program can be used by or in combination with an instruction execution system, apparatus, or device.

The program product uses any combination of one or more readable media. The readable medium may be a computer-readable signal medium or a computer-readable storage medium. The readable storage medium is, for example, but is not limited to, an electric, magnetic, optical, electromagnetic, infrared, or semi-conductive system, apparatus, or device, or any combination thereof. More specific examples of the readable storage medium (a non-exhaustive list) include: an electrical connection having one or more wires, a portable disk, a hard disk, a RAM, a ROM, an erasable programmable ROM (EPROM or a flash memory), an optical fiber, a compact disc ROM (CD-ROM), an optical storage device, a magnetic storage device, or any appropriate combination thereof.

The computer-readable signal medium includes a data signal being in a baseband or transmitted as a part of a carrier, which carries readable program code. A data signal propagated in such a way assumes a plurality of forms, including, but not limited to, an electromagnetic signal, an optical signal, or any appropriate combination thereof. Alternatively, the readable storage medium is any readable medium other than a readable storage medium, and the readable storage medium can be used to send, propagate, or transmit a program used by or in combination with an instruction execution system, apparatus, or device.

The program code included in the readable storage medium can be transmitted by using any suitable medium, including but not limited to a wireless medium, a wired medium, an optical cable, RF, or any appropriate combination thereof.

The program code for executing the operations of the present disclosure is written by using any combination of one or more programming languages. The programming languages include an object-oriented programming language such as Java and C++, and also include a conventional procedural programming language such as “C” or similar programming languages. The program code is completely executed on a user computing device, partially executed on a user device, executed as an independent software package, partially executed on a user computing device and partially executed on a remote computing device, or completely executed on a remote computing device or server. In cases involving a remote computing device, the remote computing device is connected to a user computing device through any type of network including a local area network (LAN) or a wide area network (WAN), or is connected to an external computing device (for example, through the Internet by using an Internet service provider).

In addition, the foregoing accompanying drawings are only schematic illustrations of the processes included in the method according to exemplary embodiments of the present disclosure, and are not intended to be limiting. It is easily understood that the processes illustrated in the foregoing accompanying drawings do not indicate or define the chronological order of these processes. In addition, it is also easily understood that these processes are performed, for example, synchronously or asynchronously in a plurality of modules.

Although a plurality of modules or units of a device configured to perform actions are discussed in the foregoing detailed description, such division is not mandatory. In fact, according to the exemplary embodiments of the present disclosure, the features and functions of two or more modules or units described above are embodied in one module or unit. On the contrary, the features and functions of one module or unit described above are further divided to be embodied by a plurality of modules or units.

A person skilled in the art may readily contemplate other embodiments of the present disclosure after considering the specification and practicing the invention disclosed herein. The present disclosure is intended to cover any variation, use, or adaptive change of the present disclosure. These variations, uses, or adaptive changes follow the general principles of the present disclosure and include common general knowledge or common technical means, which are not disclosed in the present disclosure, in the technology. The specification and the embodiments are merely for an illustration purpose, and the true scope and spirit of the present disclosure are subject to the claims.

It should be understood that the present disclosure is not limited to the precise structures described above and shown in the accompanying drawings, and various modifications and changes can be made without departing from the scope of the present disclosure. The scope of the present disclosure is limited only by the appended claims. It should be understood that the present disclosure is not limited to the precise structures described above and shown in the accompanying drawings, and various modifications and changes can be made without departing from the scope of the present disclosure. The scope of the present disclosure is subject only to the appended claims.

According to one aspect of the present disclosure, a polysemant meaning learning method is provided, including: extracting a plurality of first target terms and at least one adjacent term combinations of each first target term from a to-be-learned text set; respectively encoding each first target term and each adjacent term combination according to a word bank of the to-be-learned text set; obtaining a capsule network model by training by taking the encoding of each first target term as an input vector and the encoding of each adjacent term combination corresponding to each first target term as an output vector; when a to-be-recognized second target term is recognized, inputting the second target term into the capsule network model, and determining a plurality of obtained intermediate vectors as feature vectors of the second target term; and clustering the feature vectors with a cosine similarity greater than a similarity threshold to generate a representative term of each category and determining one or more meanings of the second target term according to the representative terms of one or more categories to which the feature vectors of the second target term belong.

In an exemplary embodiment of the present disclosure, the intermediate vectors are first intermediate vectors, and the capsule network model includes at least: an input layer, configured to input P-dimensional input vectors; an intermediate layer, configured to convert the input vectors into M N-dimensional first intermediate vectors; a routing layer, configured to convert the intermediate vectors into P-dimensional second intermediate vectors; and an output layer, configured to convert the second intermediate vectors into P-dimensional output vectors. P is a quantity of terms in the word bank of the to-be-learned text set, M is a preset maximum quantity of meanings, and N is a preset quantity of features.

In an exemplary embodiment of the present disclosure, the extracting a plurality of first target terms and one or more adjacent term combinations of each first target term from a to-be-learned text set includes: performing term segmentation on a plurality of to-be-learned texts in the to-be-learned text set, and determining a plurality of obtained terms as the first target terms; determining, for each of the first target terms, other first target terms, whose distance from the first target term in the to-be-learned text is less than a first threshold, as adjacent terms of the first target term; and counting mutual information between the adjacent terms of each of the first target terms, and clustering the adjacent terms whose mutual information is greater than a second threshold to obtain the one or more adjacent term combinations of the first target term.

In an exemplary embodiment of the present disclosure, the determining, for each of the first target terms, other first target terms, whose distance from the target term in the to-be-learned text is less than a first threshold, as adjacent terms of the first target term includes: determining, for each of the first target terms, other first target terms, whose distance from the first target term in the to-be-learned text is less than the first threshold, as quasi-adjacent terms of the first target term; and counting mutual information between each of the quasi-adjacent terms and the first target term, and determining the quasi-adjacent terms with mutual information between the quasi-adjacent terms and the first target term greater than a third threshold as the adjacent terms of the first target term.

In an exemplary embodiment of the present disclosure, the method further includes: constructing the word bank of the to-be-learned text set by using the plurality of the first target terms of the to-be-learned text set.

In an exemplary embodiment of the present disclosure, the clustering the feature vectors with a cosine similarity greater than a similarity threshold includes: counting a cosine similarity between each two of the feature vectors, and clustering the feature vectors with the cosine similarity greater than the similarity threshold into one category.

According to one aspect of the present disclosure, a meaning-recognition-based search result display method is provided, including: acquiring a keyword of a search instruction; inputting the keyword into a capsule network model, and determining a plurality of obtained intermediate vectors as feature vectors of the keyword; clustering feature vectors with a cosine similarity greater than a similarity threshold to generate a representative term of each category, and determining a plurality of meanings of the keyword according to the representative terms of a plurality of categories to which the feature vectors of the keyword belong; acquiring a search result according to the plurality of meanings of the keyword; ranking search results corresponding to the plurality of meanings of the keyword; and displaying the ranked search results corresponding to the plurality of meanings of the keyword.

In an exemplary embodiment of the present disclosure, the ranking search results corresponding to the plurality of meanings of the keyword includes: acquiring a first historical search record of a current user, determining a first search intention of the current user based on the first historical search record, and ranking, according to the first search intention, the search results corresponding to the plurality of meanings of the keyword.

In an exemplary embodiment of the present disclosure, the ranking search results corresponding to the plurality of meanings of the keyword includes: acquiring context information of the keyword, determining a second search intention of the current user according to the context information, and ranking, according to the second search intention, the search results corresponding to the plurality of meanings of the keyword.

In an exemplary embodiment of the present disclosure, the ranking search results corresponding to the plurality of meanings of the keyword includes: acquiring second historical search records of a plurality of users, determining search popularity of the plurality of meanings according to the second historical search records of the plurality of users, and ranking, according to the search popularity of the plurality of meanings, the search results corresponding to the plurality of meanings of the keyword.

According to one aspect of the present disclosure, a polysemant meaning learning apparatus is provided, including:

an extraction module, configured to extract a plurality of first target terms and one or more adjacent term combinations of each first target term from a to-be-learned text set;

an encoding module, configured to respectively encode each first target term and each adjacent term combination according to a word bank of the to-be-learned text set;

a training module, configured to obtain a capsule network model by training by taking the encoding of each first target term as an input vector and the encoding of each adjacent term combination corresponding to each first target term as an output vector;

a processing module, configured to, when a to-be-recognized second target term is recognized, input the second target term into the capsule network model, and determine a plurality of obtained intermediate vectors as feature vectors of the second target term; and

a clustering module, configured to cluster the feature vectors with a cosine similarity greater than a similarity threshold to generate a representative term of each category, and determine one or more meanings of the second target term according to the representative terms of one or more categories to which the feature vectors of the second target term belong.

According to one aspect of the present disclosure, a polysemant meaning learning apparatus is provided, including:

an acquisition module, configured to acquire a keyword of a search instruction;

a recognition module, configured to input the keyword into a capsule network model, and determine a plurality of obtained intermediate vectors as feature vectors of the keyword; and cluster feature vectors with a cosine similarity greater than a similarity threshold to generate a representative term of each category, and determine a plurality of meanings of the keyword according to the representative terms of a plurality of categories to which the feature vectors of the keyword belong;

a search module, configured to acquire a search result according to the plurality of meanings of the keyword; and

a display module, configured to rank search results corresponding to the plurality of meanings of the keyword, and display the ranked search results corresponding to the plurality of meanings of the keyword.

According to one aspect of the present disclosure, an electronic device is provided, including: a processor; and a memory, configured to store executable instructions of the processor; the processor being configured to execute the executable instructions to perform the following operations:

extracting a plurality of first target terms and one or more adjacent term combinations of each first target term from a to-be-learned text set; respectively encoding each first target term and each adjacent term combination according to a word bank of the to-be-learned text set; obtaining a capsule network model by training by taking the encoding of each first target term as an input vector and the encoding of each adjacent term combination corresponding to each first target term as an output vector; when a to-be-recognized second target term is recognized, inputting the second target term into the capsule network model, and determining a plurality of obtained intermediate vectors as feature vectors of the second target term; and clustering the feature vectors with a cosine similarity greater than a similarity threshold to generate a representative term of each category, and determining one or more meanings of the second target term according to the representative terms of one or more categories to which the feature vectors of the second target term belong.

In an exemplary embodiment of the present disclosure, the processor is configured to execute the executable instructions to perform the following operations: performing term segmentation on a plurality of to-be-learned texts in the to-be-learned text set, and determining a plurality of obtained terms as the first target terms; determining, for each of the first target terms, other first target terms, whose distance from the first target term in the to-be-learned text is less than a first threshold, as adjacent terms of the first target term; and counting mutual information between the adjacent terms of each of the first target terms, and clustering the adjacent terms whose mutual information is greater than a second threshold to obtain the one or more adjacent term combinations of the first target term.

In an exemplary embodiment of the present disclosure, the processor is configured to execute the executable instructions to perform the following operations: determining, for each of the first target terms, other first target terms, whose distance from the first target term in the to-be-learned text is less than the first threshold, as quasi-adjacent terms of the first target term; and counting mutual information between each of the quasi-adjacent terms and the first target term, and determining the quasi-adjacent terms with mutual information between the quasi-adjacent terms and the first target term greater than a third threshold as the adjacent terms of the first target term.

In an exemplary embodiment of the present disclosure, the processor is configured to execute the executable instructions to perform the following operation: constructing the word bank of the to-be-learned text set by using all the plurality of the first target terms of the to-be-learned text set.

In an exemplary embodiment of the present disclosure, the processor is configured to execute the executable instructions to perform the following operation: counting a cosine similarity between each two of the feature vectors, and clustering the feature vectors with the cosine similarity greater than the similarity threshold into one category.

According to one aspect of the present disclosure, an electronic device is provided, including: a processor; and a memory, configured to store executable instructions of the processor;

the processor being configured to execute the executable instructions to perform the following operations:

acquiring a keyword of a search instruction; inputting the keyword into a capsule network model, and determining a plurality of obtained intermediate vectors as feature vectors of the keyword; clustering feature vectors with a cosine similarity greater than a similarity threshold to generate a representative term of each category, and determining a plurality of meanings of the keyword according to the representative terms of a plurality of categories to which the feature vectors of the keyword belong; acquiring a search result according to the plurality of meanings of the keyword; ranking search results corresponding to the plurality of meanings of the keyword; and displaying the ranked search results corresponding to the plurality of meanings of the keyword.

In an exemplary embodiment of the present disclosure, the processor is configured to execute the executable instructions to perform the following operation: acquiring a first historical search record of a current user, determining a first search intention of the current user based on the first historical search record, and ranking, according to the first search intention, the search results corresponding to the plurality of meanings of the keyword; or

acquiring context information of the keyword, determining a second search intention of the current user according to the context information, and ranking, according to the second search intention, the search results corresponding to the plurality of meanings of the keyword; or

acquiring second historical search records of a plurality of users, determining search popularity of the plurality of meanings according to the second historical search records of the plurality of users, and ranking, according to the search popularity of the plurality of meanings, the search results corresponding to the plurality of meanings of the keyword.

According to one aspect of the present disclosure, a computer-readable storage medium storing a computer program is provided. The computer program, when executed by a processor, performs the polysemant meaning learning method according to any one of the foregoing.

According to one aspect of the present disclosure, a computer-readable storage medium storing a computer program is provided. The computer program, when executed by a processor, performs the meaning-recognition-based search result display method according to any one of the foregoing.

The exemplary embodiment of the present disclosure has the following beneficial effects: a capsule network model is trained based on encoding of a first target term and adjacent term combinations in a to-be-learned text set, then a second target term is processed by using the trained capsule network model, to obtain feature vectors of the second target term, and finally the feature vectors of the second target term are clustered, to determine one or more meanings of the second target term according to a representative term of a category to which the second target term belongs. On the one hand, this exemplary embodiment provides an effective polysemant meaning learning method, which can implement multi-meaning recognition on a target term for an unlabeled to-be-learned text set, and has strong universality. Moreover, the implementation of the method requires a lower labor cost. On the other hand, based on a learned meaning of a second target term, in the application, a plurality of results of semantic recognition on a text including the second target term can be generated, different meanings of the second target term in different contexts can be distinguished, and the accuracy of text recognition is improved.

1. A polysemant meaning learning method, comprising:
extracting a plurality of first target terms and one or more adjacent term combinations of each first target term from a to-be-learned text set;
respectively encoding each first target term and each adjacent term combination according to a word bank of the to-be-learned text set;
obtaining a capsule network model by training by taking the encoding of each first target term as an input vector and the encoding of each adjacent term combination corresponding to each first target term as an output vector;
when a to-be-recognized second target term is recognized, inputting the second target term into the capsule network model, and determining a plurality of obtained intermediate vectors as feature vectors of the second target term; and
clustering the feature vectors with a cosine similarity greater than a similarity threshold to generate representative terms of one or more categories to which the feature vectors of the second target term belong, and determining one or more meanings of the second target term according to the representative terms of one or more categories to which the feature vectors of the second target term belong.

2. The method according to claim 1, wherein the intermediate vectors are first intermediate vectors, and the capsule network model comprises at least:
an input layer, configured to input P-dimensional input vectors;
an intermediate layer, configured to convert the input vectors into M N-dimensional first intermediate vectors;
a routing layer, configured to convert the first intermediate vectors into P-dimensional second intermediate vectors; and
an output layer, configured to convert the second intermediate vectors into P-dimensional output vectors,
wherein P is a quantity of terms in the word bank of the to-be-learned text set, M is a preset maximum quantity of meanings, and N is a preset quantity of features.

3. The method according to claim 1, wherein the extracting a plurality of first target terms and one or more adjacent term combinations of each first target term from a to-be-learned text set comprises:
performing term segmentation on a plurality of to-be-learned texts in the to-be-learned text set, and determining a plurality of obtained terms as the first target terms;
determining, for each of the first target terms, other first target terms, whose distance from the first target term in the to-be-learned text is less than a first threshold, as adjacent terms of the first target term; and
counting mutual information between the adjacent terms of each of the first target terms, and clustering the adjacent terms whose mutual information is greater than a second threshold to obtain the one or more adjacent term combinations of the first target term.

4. The method according to claim 3, wherein determining, for each of the first target terms, other first target terms, whose distance from the first target term in the to-be-learned text is less than a first threshold, as adjacent terms of the first target term comprises:
determining, for each of the first target terms, other first target terms, whose distance from the first target term in the to-be-learned text is less than the first threshold, as quasi-adjacent terms of the first target term; and
counting mutual information between each of the quasi-adjacent terms and the first target term, and determining the quasi-adjacent terms with mutual information between the quasi-adjacent terms and the first target term greater than a third threshold as the adjacent terms of the first target term.

5. The method according to claim 1, further comprising:
constructing the word bank of the to-be-learned text set by using the plurality of the first target terms of the to-be-learned text set.

6. The method according to claim 1, wherein the clustering the feature vectors with a cosine similarity greater than a similarity threshold comprises:
counting a cosine similarity between each two of the feature vectors, and clustering the feature vectors with the cosine similarity greater than the similarity threshold into one category.

7. A meaning-recognition-based search result display method, comprising:
acquiring a keyword of a search instruction;
inputting the keyword into a capsule network model, and determining a plurality of obtained intermediate vectors as feature vectors of the keyword;
clustering feature vectors with a cosine similarity greater than a similarity threshold to generate representative terms of one or more categories to which the feature vectors of the second target term belong, and determining a plurality of meanings of the keyword according to the representative terms of a plurality of categories to which the feature vectors of the keyword belong;
acquiring a search result according to the plurality of meanings of the keyword;
ranking search results corresponding to the plurality of meanings of the keyword; and
displaying the ranked search results corresponding to the plurality of meanings of the keyword.

8. The method according to claim 7, wherein the ranking search results corresponding to the plurality of meanings of the keyword comprises:
acquiring a first historical search record of a current user, determining a first search intention of the current user based on the first historical search record, and ranking, according to the first search intention, the search results corresponding to the plurality of meanings of the keyword.

9-10. (canceled)

11. An electronic device, comprising:
a processor; and
a memory, configured to store executable instructions of the processor,
wherein the processor is configured to execute the executable instructions to perform the following operations:
extracting a plurality of first target terms and one or more adjacent term combinations of each first target term from a to-be-learned text set;
respectively encoding each first target term and each adjacent term combination according to a word bank of the to-be-learned text set;
obtaining a capsule network model by training by taking the encoding of each first target term as an input vector and the encoding of each adjacent term combination corresponding to each first target term as an output vector;
when a to-be-recognized second target term is recognized, inputting the second target term into the capsule network model, and determining a plurality of obtained intermediate vectors as feature vectors of the second target term; and
clustering the feature vectors with a cosine similarity greater than a similarity threshold to generate representative terms of one or more categories to which the feature vectors of the second target term belong, and determining one or more meanings of the second target term according to the representative terms of one or more categories to which the feature vectors of the second target term belong.

12. The electronic device according to claim 11, wherein the processor is configured to execute the executable instructions to perform the following operations:
performing term segmentation on a plurality of to-be-learned texts in the to-be-learned text set, and determining a plurality of obtained terms as the first target terms;
determining, for each of the first target terms, other first target terms, whose distance from the first target term in the to-be-learned text is less than a first threshold, as adjacent terms of the first target term; and
counting mutual information between the adjacent terms of each of the first target terms, and clustering the adjacent terms whose mutual information is greater than a second threshold to obtain the one or more adjacent term combinations of the first target term.

13. The electronic device according to claim 12, wherein the processor is configured to execute the executable instructions to perform the following operations:
determining, for each of the first target terms, other first target terms, whose distance from the first target term in the to-be-learned text is less than the first threshold, as quasi-adjacent terms of the first target term; and
counting mutual information between each of the quasi-adjacent terms and the first target term, and determining the quasi-adjacent terms with mutual information between the quasi-adjacent terms and the first target term greater than a third threshold as the adjacent terms of the first target term.

14. The electronic device according to claim 11, wherein the processor is configured to execute the executable instructions to perform the following operation:
constructing the word bank of the to-be-learned text set by using the plurality of the first target terms of the to-be-learned text set.

15. The electronic device according to claim 11, wherein the processor is configured to execute the executable instructions to perform the following operation:
counting a cosine similarity between each two of the feature vectors, and clustering the feature vectors with the cosine similarity greater than the similarity threshold into one category.

16-18. (canceled)

19. The electronic device according to claim 11, comprising
an input layer, configured to input P-dimensional input vectors;
an intermediate layer, configured to convert the input vectors into M N-dimensional first intermediate vectors;
a routing layer, configured to convert the first intermediate vectors into P-dimensional second intermediate vectors; and
an output layer, configured to convert the second intermediate vectors into P-dimensional output vectors,
wherein P is a quantity of terms in the word bank of the to-be-learned text set, M is a preset maximum quantity of meanings, and N is a preset quantity of features.

20. The method according to claim 7, wherein the ranking search results corresponding to the plurality of meanings of the keyword comprises:
acquiring context information of the keyword, determining a second search intention of the current user according to the context information, and ranking, according to the second search intention, the search results corresponding to the plurality of meanings of the keyword.

21. The method according to claim 7, wherein the ranking search results corresponding to the plurality of meanings of the keyword comprises:
acquiring second historical search records of a plurality of users, determining search popularity of the plurality of meanings according to the second historical search records of the plurality of users, and ranking, according to the search popularity of the plurality of meanings, the search results corresponding to the plurality of meanings of the keyword.

22. The method according to claim 21, wherein the search popularity is a quantity of searches or frequency of searches.
